(19) United States
(12) Patent Application Publication
(10) Pub. No.: US 2017/0024396 A1
(43) Pub. Date: Jan. 26, 2017

(54) DETERMINING APPLICATION DEPLOYMENT RECOMMENDATIONS

(71) Applicant: HEWLETT PACKARD ENTERPRISE DEVELOPMENT LP, Houston, TX (US)

(72) Inventors: Suparna Adarsh, Bangalore (IN); SIMHA AJEYAH H, Bangalore (IN)

(21) Appl. No.: 15/303,068

(22) PCT Filed: Jun. 12, 2014
(86) PCT No.: PCT/US2014/042111

§ 371 Date: Oct. 10, 2016

(30) Foreign Application Priority Data
Apr. 30, 2014 (IN) 2200/CHE/2014

(51) Int. Cl. G06F 17/30; H04L 29/08; G06F 9/445

(52) U.S. Cl. CPC G06F 17/3053; G06F 8/60; G06F 17/30867; H04L 67/10

(57) ABSTRACT

In one example of the disclosure, performance data for a plurality of cloud-based application deployment configurations is received. A database is generated, the database including associations of the configurations with a plurality of performance features, and including an association of a performance score to each feature. A set of performance requirements for cloud-based deployment of a first application is received. A recommendation of a first configuration for cloud-based deployment of the first application is determined based upon performance scores from the database. The recommendation is sent to a computing device.

### BACKGROUND

The rise of cloud computing in organizations of different sizes provides faster and broader access to computing resources with reduced investments in hardware. Organizations that move application services to the cloud in many cases can free up personnel and funds that would otherwise be devoted to hosting applications, and thereby accelerate go-to-market strategies.

### DRAWINGS

FIG. 1 is a block diagram depicting an example environment in which various embodiments may be implemented.

FIG. 2 is a block diagram depicting an example of a system to determine cloud-based application deployment recommendations.

FIG. 3 is a block diagram depicting an example data structure for a system to determine cloud-based application deployment recommendations.

FIG. 4 is a block diagram depicting a memory resource and a processing resource according to an example.

FIGS. 5, 6A, 6B, 7A, and 7B illustrate an example of determining cloud-based application deployment recommendations.

FIG. 8 is a flow diagram depicting steps taken to implement an example.

### DETAILED DESCRIPTION

### Introduction

In order to avail itself of the advantages of moving an application service to the cloud relative to hosting the application internally, an organization's IT department typically is tasked with identifying the right cloud-based application deployment configuration for hosting the application in cloud service provider based on the business needs. As used herein, a cloud-based application deployment configuration (sometimes referred to herein as a “CAD configuration”) refers generally to a combination of software, platforms and/or infrastructure that enables an application to be accessed via an internet or intranet. In examples, a CAD configuration may include, but is not limited to, elements of a platform as a service configuration (“PaaS”) or elements of an infrastructure as a service configuration (“IaaS”). In examples, a CAD deployment configuration may be host an application in a public, private or hybrid network. In examples, the CAD deployment configuration may be implemented via a system including a large number of computers connected through a communication network such as the Internet. In some examples, the CAD deployment configuration may be facilitated utilizing virtual servers or other virtual hardware simulated by software running on an actual hardware component.

Choosing among the many various CAD configuration combinations for deployment of an application in the cloud can involve considering various factors such as security, performance, storage, availability and the cost structures associated with it. For example, some applications to be moved to the cloud will require high security and high performance. Other applications to be moved to the cloud may require high storage capacity and disaster recovery. Currently organizations typically have employees manually gather data and choose which CAD configuration to select for specific application deployment needs. This process can be time-consuming and expensive. Adding to the complication, application needs typically change over a period of time and the process of manually identifying an optimal CAD deployment configuration may need to be repeated each with each change.

To address these issues, various embodiments described in more detail below provide a system and a method to determine cloud-based application deployment configuration recommendations. In an example, performance data for a set of CAD configuration is received. In certain examples, the performance data includes performance data elements received over a time period. A database is generated, the database including associations of CAD configuration from the set with named performance features. The database additionally includes an association of performance scores to each of the named performance features. In examples, the performance data includes captured behavior data indicative of the first application in a plurality of cloud-based deployment configurations, and the performance scores are generated based upon the behavior data. In other examples, the performance scores may be scores generated based upon the performance data, the performance data being data included within a product manual, support matrix, performance test report, product website, data sheet, or pricing guide. A set of performance requirements for cloud-based deployment of a first application is received. A recommendation of a first configuration for cloud-based deployment of the application is determined based upon performance scores from the database. The determined recommendation is then sent to a computing device for display and/or to initiate execution of the application according to the recommendation.

In this manner, examples described herein may present an automated and efficient manner to enable determination of cloud-based application deployment configuration recommendations for applications. Disclosed examples provide a method and system to identify a best CAD deployment configuration based on an organization's application deployment requirements and scored behaviors of the application in multiple CAD deployment configurations. Examples described herein may consider application requirement parameters including, but not limited to, cost, performance, security, geographic location, reliability, high availability, and disaster recovery, etc. Examples described herein may enable organizations to share this system across teams within the organization, thus accomplishing significant savings in time and costs, and eliminating errors inherent with manual computations

The following description is broken into sections. The first, labeled “Environment,” describes an environment in which various embodiments may be implemented. The second section, labeled “Components,” describes examples of various physical and logical components for implementing various embodiments. The third section, labeled “Illustrative Example,” presents an example of determining cloud-based application deployment recommendations based upon performance scores associated with performance features. The fourth section, labeled “Operation,” describes steps taken to implement various embodiments.

### Environment

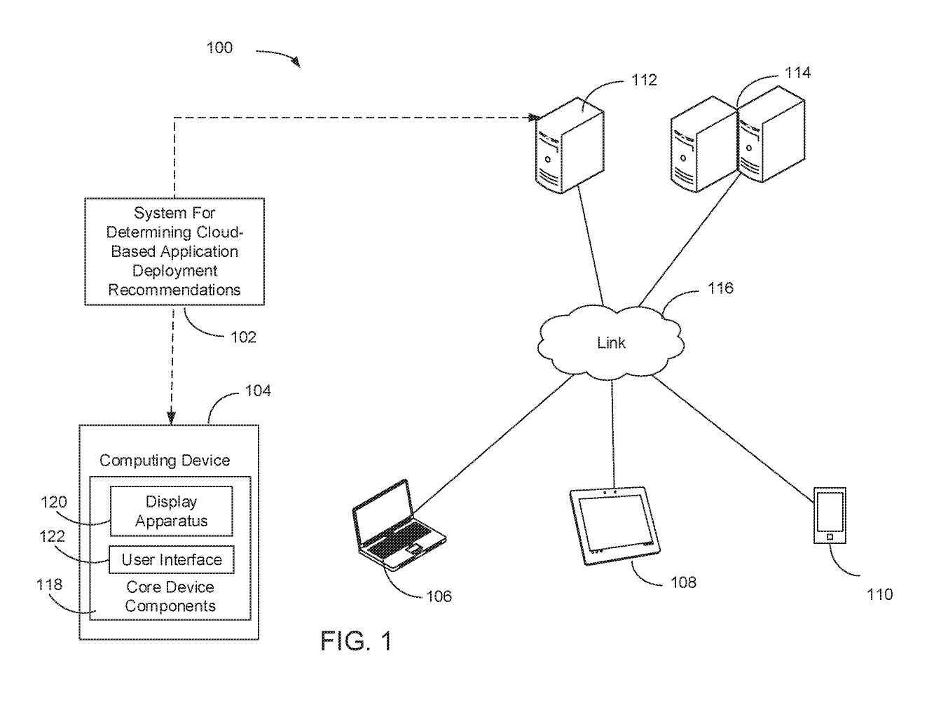

FIG. 1 depicts an example environment 100 in which embodiments may be implemented as a system 102 to determine cloud-based application deployment recommendations. Environment 100 is show to include computing device 104, client devices 106, 108, and 110, server device 112, and server devices 114. Components 104-114 are interconnected via link 116.

Link 116 represents generally any infrastructure or combination of infrastructures configured to enable an electronic connection, wireless connection, other connection, or combination thereof, to enable data communication between components 104 106 108 110 112 114. Such infrastructure or infrastructures may include, but are not limited to, one or more of a cable, wireless, fiber optic, or remote connections via telecommunication link, an infrared link, or a radio frequency link. For example, link 116 may represent the internet, one or more intranets, and any intermediate routers, switches, and other interfaces. As used herein an “electronic connection” refers generally to a transfer of data between components, e.g., between two computing devices, that are connected by an electrical conductor. A “wireless connection” refers generally to a transfer of data between two components, e.g., between two computing devices, that are not directly connected by an electrical conductor. A wireless connection may be via a wireless communication protocol or wireless standard for exchanging data.

Client devices 106-110 represent generally any computing device with which a user may interact to communicate with other client devices, server device 112, and/or server devices 114 via link 116. Server device 112 represent generally any computing device configured to serve an application and corresponding data for consumption by components 104-110. Server devices 114 represents generally any group of computing devices collectively configured to serve an application and corresponding data for consumption by components 104-110.

Computing device 104 represents generally any computing device with which a user may interact to communicate with client devices 106-110, server device 112, and/or server devices 114 via link 116. Computing device 104 is shown to include core device components 118. Core device components 118 represent generally the hardware and programming for providing the computing functions for which device 104 is designed. Such hardware can include a processor and memory, a display apparatus 120, and a user interface 122. The programming can include an operating system and applications. Display apparatus 120 represents generally any combination of hardware and programming configured to exhibit or present a message, image, view, or other presentation for perception by a user, and can include, but is not limited to, a visual, tactile or auditory display. In examples, the display device may be or include a monitor, a touchscreen, a projection device, a touch/sensory display device, or a speaker. User interface 122 represents generally any combination of hardware and programming configured to enable interaction between a user and device 104 such that the user may effect operation or control of device 104. In examples, user interface 122 may be, or include, a keyboard, keypad, or a mouse. In some examples, the functionality of display apparatus 120 and user interface 122 may be combined, as in the case of a touchscreen apparatus that may enable presentation of images at device 104, and that also may enable a user to operate or control functionality of device 104.

System 102, discussed in more detail below, represents generally a combination of hardware and programming configured to enable determination of cloud-based application deployment recommendations. In an example, system 102 is to receive performance data for a plurality of CAD deployment configurations. System 102 is to generate a database that includes associations of the configurations with a plurality of performance features. The database includes an association of a performance score to each feature. System 102 is to receive a set of performance requirements for cloud-based deployment of a first application. In an example, system 102 may access a repository that includes conversion data associating semantic performance values with numerical requirements, and convert the semantic requirements to numerical requirements based upon the conversion data. System 102 is to determine, based upon performance scores from the database, a recommendation of a first configuration for cloud-based deployment of the application. System 102 is to then send the determined recommendation to a computing device, e.g., to be displayed at the computing device, or for the computing device to utilize to initiate execution of the application at the computing device according to the recommendation.

In some examples, system 102 may be wholly integrated within core device components 118. In other examples, system 102 may be implemented as a component of any of computing device 104, client devices 106-110, server device 112, or server devices 114 where it may take action based in part on data received from core device components 118 via link 116. In other examples, system 102 may be distributed across computing device 104, and any of client devices 106-110, server device 112, or server devices 114. In a particular example, components implementing the receipt of the performance data, the generation of the associations database, receipt of the performance requirements for cloud-based deployment of the first application, the determination of the configuration recommendation, and sending of the recommendation to the computing device may be included within a server device 112. Continuing with this particular example, a component implementing the accessing of the repository with conversion data and conversion of the semantic requirements to numerical requirements based upon the conversion data may be a component included within computing device 104. Other distributions of system 102 across computing device 104, client devices 106-110, server device 112, and server devices 114 are possible and contemplated by this disclosure. It is noted that all or portions of the system 102 to provide media navigation recommendations may also be included on client devices 106, 108 or 110.

### Components

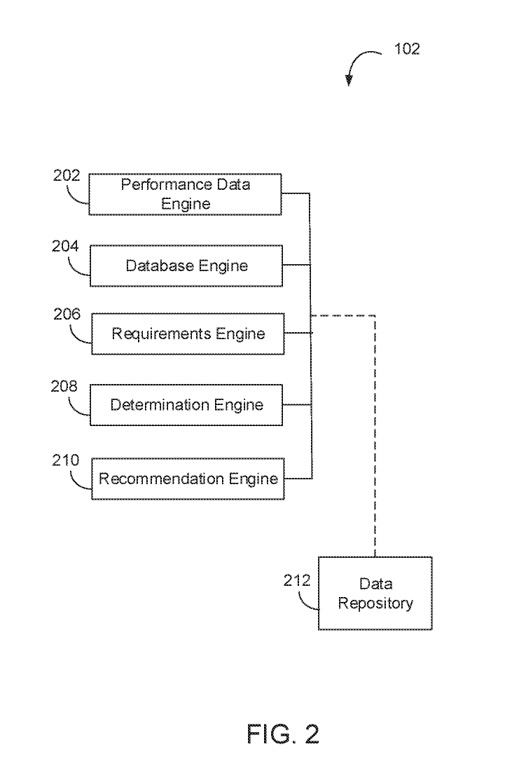

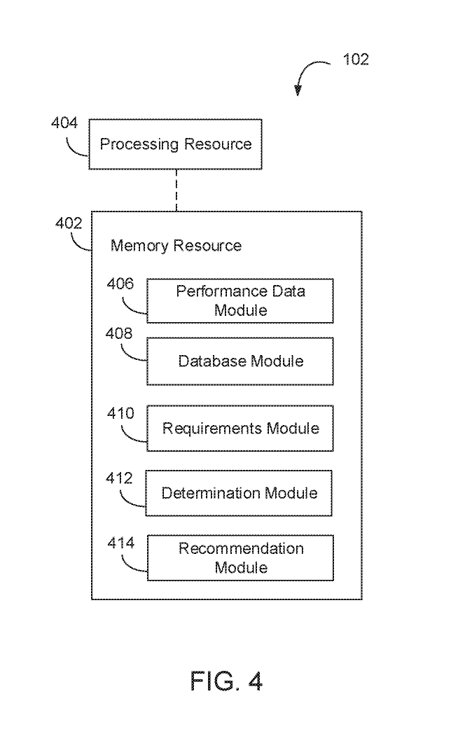

FIGS. 2, 3, and 4 depict examples of physical and logical components for implementing various embodiments. In FIG. 2 various components are identified as engines 202 204 206 208 210. In describing engines 202 204 206 208 210 focus is on each engine's designated function. However, the term engine, as used herein, refers generally to a combination of hardware and programming configured to perform a designated function. As is illustrated later with respect to FIG. 4, the hardware of each engine, for example, may include one or both of a processor and a memory, while the programming may be code stored on that memory and executable by the processor to perform the designated function.

FIG. 2 is a block diagram depicting components of a system 102 to determine and provide cloud-based application deployment recommendations. In this example, system 102 includes performance data engine 202, database engine 204, requirements engine 206, determination engine 208, and recommendation engine 210. In performing their respective functions, engines 202 204 206 208 210 may access data repository 212. Repository 212 represents generally any memory accessible to system 102 that can be used to store and retrieve data.

In an example, performance data engine 202 represents a combination of hardware and programming configured to receive, via a network, e.g. link 116, performance data for a set of CAD configurations. Database engine 204 represents a combination of hardware and programming configured to generate a database that includes associations of the received set of cloud-based application deployment configurations with specified performance features. The database also includes associations of performance scores with each of the identified performance features. Requirements engine 206 represents a combination of hardware and programming configured to receive a set of performance requirements for cloud-based deployment of a specified application. Determination engine 208 represents a combination of hardware and programming configured to determine a recommendation of an optimal configuration for cloud-based deployment of the specified application, with the determination based at least in part upon performance scores from the database. Recommendation engine 210 represents a combination of hardware and programming configured to send the determined recommendation of the optimal cloud-based application deployment configuration for the specified application to a computing device. In one example, the recommendation is sent to the computing device, e.g. the computing device from which the requirements were received, for display. In another example, the recommendation is sent to the computing device to initiate or implement execution of deployment of the specified application according to the recommendation.

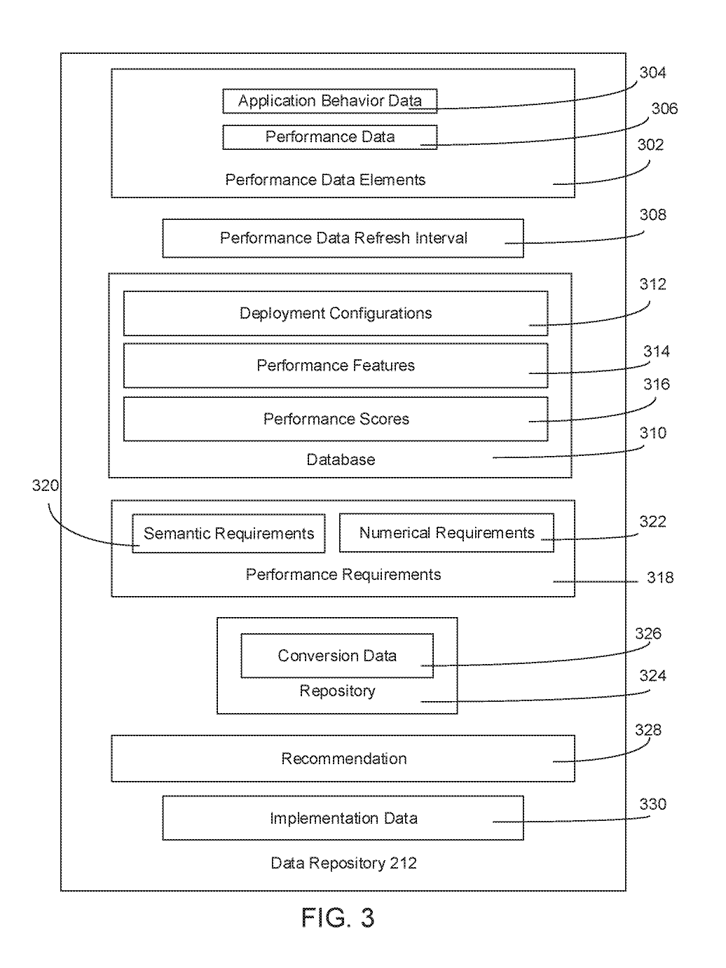

FIG. 3 depicts an example implementation of data repository 212. In this example, repository 212 includes performance data elements 302, application behavior data 304, performance data 306, performance data refresh interval 308, database 310, deployment configurations 312, performance features 314, performance scores 316, performance requirements 318, semantic requirements 320, numerical requirements 322, repository 324, conversion data 326, recommendation 328, and implementation data 330.

Referring back to FIG. 3 in view of FIG. 2, in an example, performance data engine 202 (FIG. 2) receives, via a network 116 (FIG. 1) performance data elements 302 for a set or collection of cloud-based application deployment configurations 312. In examples, the performance data engine 302 receives the performance data elements 302 over a time period. In particular examples, the performance data engine 202 may automatically receive the performance data elements 302 over regular intervals, e.g., monthly, daily, or even hourly.

In an example, each of the received cloud-based application deployment configurations, when compared to another configuration within the set or collection, includes at least one differentiating element. In examples, the differentiating element as between possible or available application deployment configurations may be, but is not limited to, a differentiating database service element, a differentiating web service element, a differentiating firewall service element, a differentiating load balancing service element, a differentiating high availability element, or a differentiating disaster recovery element.

Continuing with the example of FIG. 3 in view of FIG. 2, the performance data engine 202 is configured to capture application behavior data 304 that is indicative the behavior of one or more software applications, when the one or more applications are actually deployed in each of the plurality of cloud-based deployment configurations 312. In this example, the performance data engine 202 in turn generates performance scores 316 based upon the application behavior data 304. In other examples, the performance data engine 202 may generate the performance scores 316 based upon performance data 306 previously captured by performance data engine 202, or which was captured by a third party and thereafter received by performance data engine 202. In examples, the performance data 306 may be, but is not limited to, data included within a product manual, a support matrix, a performance test report, a product website, a data sheet, or a pricing guide.

Continuing with the example of FIG. 3 in view of FIG. 2, database engine 204 (FIG. 2) generates a database that includes associations of the deployment configurations 312 with a set or collection of performance features 314, and includes an association of a performance score 316 to each feature 314. In examples, the performance features may include, but are not limited to, a cost feature, a quality of service feature, a security feature, a geographic location feature, a reliability feature, an application availability feature, or a disaster recovery capability feature. In examples, generating the database may include aggregating descriptions of the set or collection of deployment configurations 312 in the database 310, and applying tags to the descriptions that associate the configurations 312 with performance features 314 and performance scores 316.

In an example, requirements engine 206 (FIG. 2) receives, via a network 116 (FIG. 1), a set or collection of performance requirements 318 for cloud-based deployment of a first application. In an example, the performance requirements 318 may be requirements that were provided to a first computing device via a user interface at the first device (e.g., via user interface 122 included within computing device 104, FIG. 1). In examples, the set or collection of performance requirements 318 may include, but are not limited to, a cost requirement, a quality of service requirement, a security requirement, a geographic location requirement, a reliability requirement, an application availability requirement, or a disaster recovery capability requirement.

In a particular example, requirements engine 206 converts performance requirements that are received in semantic form 320 to numerical performance requirements 322. In an example, the requirements engine 206 may access a repository 324 that includes conversion data 326 that includes associations of semantic performance values 320 with numerical performance requirements 322, and converts the semantic performance requirements 320 to numerical requirements 322 based upon the conversion data 326. In the example illustrated at FIG. 3, the repository 324 is separate from database 310. This example is not meant to be exclusive, however. In other examples, the repository 324 with conversion data 326 may be partially or totally included within database 310.

Continuing with the example of FIG. 3 in view of FIG. 2, determination engine 208 (FIG. 2) determines, based upon performance scores 316 from the database 310, a recommendation 328 of a first configuration from the set or collection of deployment configurations 312 for cloud-based deployment of the first application.

In an example, recommendation engine 210 may send the recommendation 328 to the first device that was the computing device at which a user provided the requirements for display (e.g., for display at display apparatus 120 included within computing device 104, FIG. 1). In another example, recommendation engine 210 may send recommendation implementation data 330 to a cloud server included within or otherwise associated with the recommendation solution to initiate deployment or execution of the first application according to the recommendation 328.

In the foregoing discussion of FIGS. 2-3, engines 202 204 206 208 210 were described as combinations of hardware and programming. Engines 202 204 206 208 210 may be implemented in a number of fashions. Looking at FIG. 4 the programming may be processor executable instructions stored on a tangible memory resource 402 and the hardware may include a processing resource 404 for executing those instructions. Thus memory resource 402 can be said to store program instructions that when executed by processing resource 404 implement system 102 of FIGS. 1 and 2.

Memory resource 402 represents generally any number of memory components capable of storing instructions that can be executed by processing resource 404. Memory resource 402 is non-transitory in the sense that it does not encompass a transitory signal but instead is made up of more or more memory components configured to store the relevant instructions. Memory resource 402 may be implemented in a single device or distributed across devices. Likewise, processing resource 404 represents any number of processors capable of executing instructions stored by memory resource 402. Processing resource 404 may be integrated in a single device or distributed across devices. Further, memory resource 402 may be fully or partially integrated in the same device as processing resource 404, or it may be separate but accessible to that device and processing resource 404.

In one example, the program instructions can be part of an installation package that when installed can be executed by processing resource 404 to implement system 102. In this case, memory resource 402 may be a portable medium such as a CD, DVD, or flash drive or a memory maintained by a server from which the installation package can be downloaded and installed. In another example, the program instructions may be part of an application or applications already installed. Here, memory resource 402 can include integrated memory such as a hard drive, solid state drive, or the like.

In FIG. 4, the executable program instructions stored in memory resource 402 are depicted as performance data module 406, database module 408, requirements module 410, determination module 412, and recommendation module 414. Performance data module 406 represents program instructions that when executed by processing resource 404 may perform any of the functionalities described above in relation to performance data engine 202 of FIG. 2. Database module 408 represents program instructions that when executed by processing resource 404 may perform any of the functionalities described above in relation to database engine 204 of FIG. 2. Requirements module 410 represents program instructions that when executed by processing resource 404 may perform any of the functionalities described above in relation to requirements engine 206 of FIG. 2. Determination module 412 represents program instructions that when executed by processing resource 404 may perform any of the functionalities described above in relation to determination engine 208 of FIG. 2. Recommendation module 414 represents program instructions that when executed by processing resource 404 may perform any of the functionalities described above in relation to recommendation engine 210 of FIG. 2.

### Illustrative Example

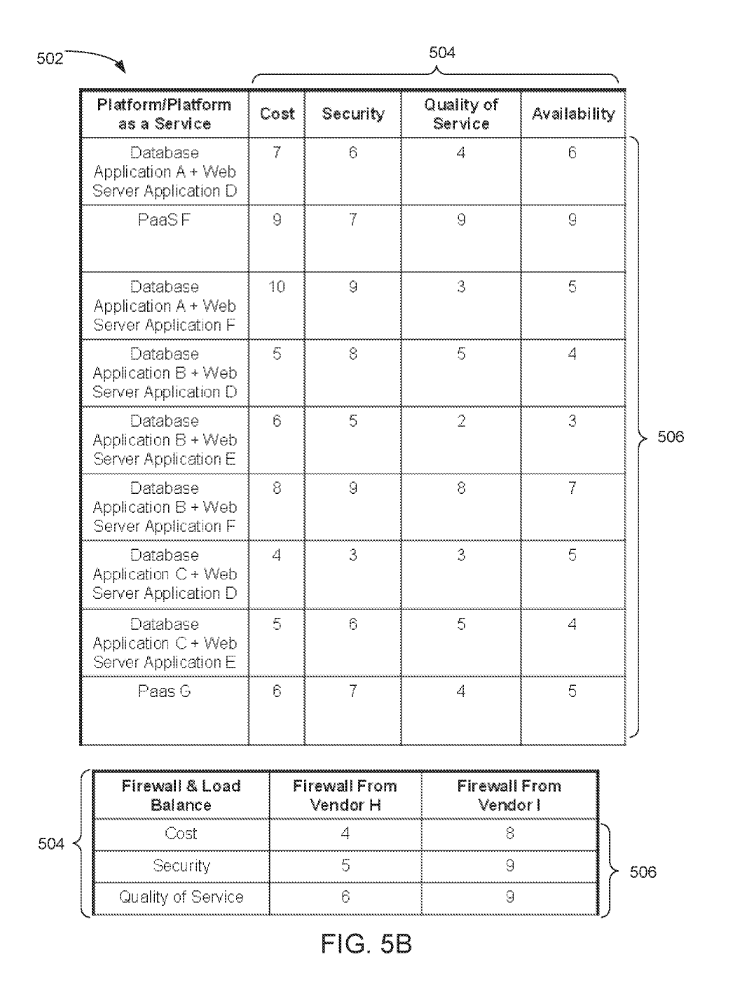

FIGS. 5, 6A, 6B, 7A, and 7B illustrate an example of determining cloud-based application deployment recommendations. Turning to FIG. 5, in an example, system 102 (FIG. 2) receives, via a network 116 (FIG. 1) performance data 502 for applications executing in a cloud-based application deployment configurations. In this example, the performance data 502 is for the various CAD configuration combinations that can occur when choosing among three database applications (“Database Application A”, “Database Application B”, and “Database Application C”), among three potential web server applications (“Web Server Application D”, “Web Server Application E”, and “Web Server Application F”). In this example, the performance data 502 is also for two Platform as a Service offerings (“PaaS” F) and (“PaaS G”). In this example, the performance data 502 is also for two firewall and load balancing offerings (“Firewall from Vendor H” and “Firewall from Vendor I”). In an example, system 102 may receive the performance data 502 automatically over regular intervals, e.g., monthly, daily, or even hourly.

Continuing at FIG. 5 system 102 generates a database that includes associations of the deployment configurations with a set of performance features 504, and includes an association of a performance score 506 to each feature 504. In this example, the performance features 506 considered include Platform/Platform as a Service features of cost, security, quality of service, and availability. In this example, the performance features considered include Firewall and Load Balancing features of cost, security, and quality of service.

In this example, the performance scores 506 are scores that are generated by system 102 based upon behavior data captured by system 102, the performance data indicative of behaviors of a specified application “Business Application Z” in multiple cloud-based deployment configurations. In another example, system 102 may generate the performance scores based upon the performance data, with respect to a specific application or a group of applications, that were captured by a third party and thereafter received by system 102.

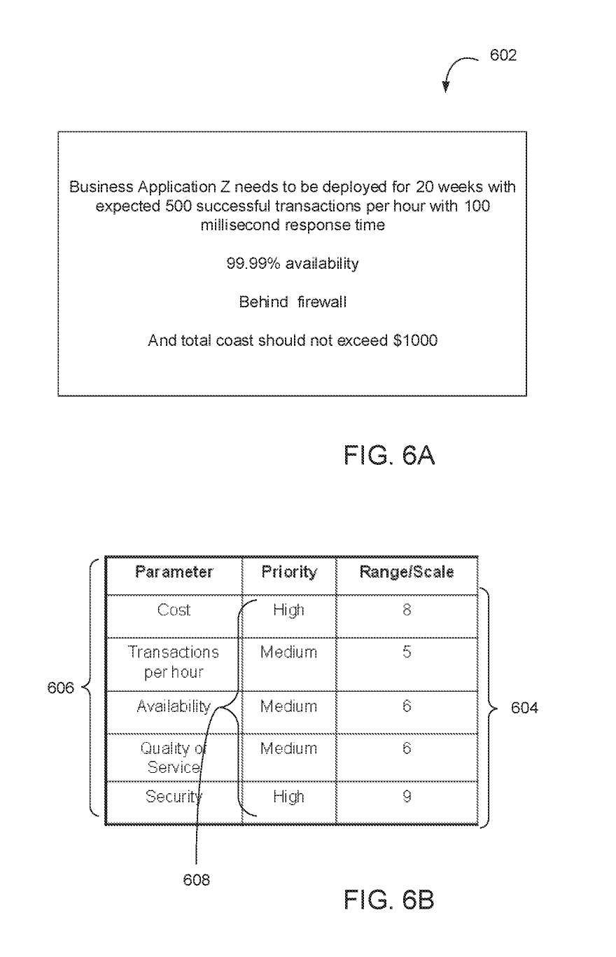

Moving to FIG. 6A, in this example system 102 (FIG. 2) receives, via a network 116 (FIG. 1), a set of performance requirements for cloud-based deployment of Business Application Z. In an example, the performance requirements may be requirements that were provided to a first computing device via a user interface at the first device (e.g., via user interface 122 included within computing device 104, FIG. 1). In this example, the set of performance requirements are initially received in semantic form 602 (e.g., “needs to deployed for 20 weeks with 500 successful transactions per hour with 100 millisecond response time”, “99.99% availability”, “behind firewall”, and “total cost should not exceed $1000”).

Moving to FIG. 6B, system 102 converts the performance requirements that were received in semantic form 602 (FIG. 6A) to numerical performance requirements 604. In an example, system 102 may access a repository (e.g., repository 324, FIG. 3) that includes conversion data (e.g., conversion data 326, FIG. 3) that includes associations of semantic performance values 602 (FIG. 6A) with the numerical performance requirements 604, and converts the semantic performance requirements 602 to the numerical requirements 604 based upon the conversion data. In this example, system 102 as intermediate step in converting the semantic requirements 602 into numerical requirements may parse the semantic requirements 602 into a set of requirements parameters 606 (“cost”, “transactions per hour”, “availability”, “quality of service”, and “security”) and assign the requirements parameters 606 to a “low priority”, “medium priority”, or “high priority” categories 608. In this example, system 102 may convert the parsed parameter 606 and priority designations 608 into the “range/scale” numerical performance requirements 604.

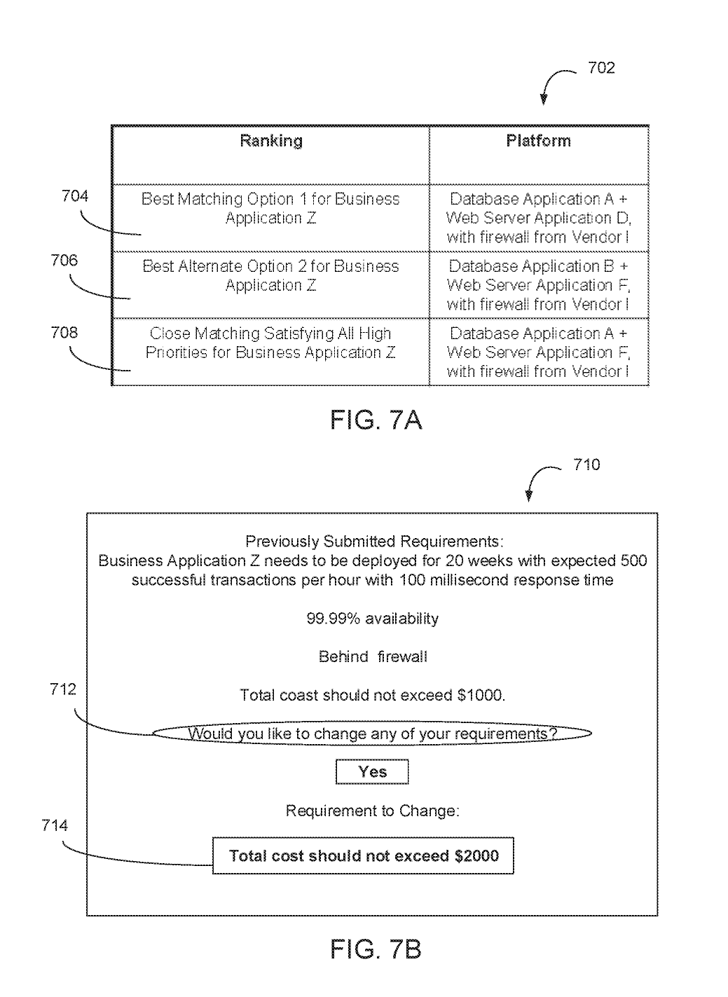

Moving to FIG. 7A, in this example system 102 determines, based upon the performance scores 506 from the database, recommendations 702 of configurations for cloud-based deployment of Business Application Z taken from the set of potential deployment configurations illustrated in FIG. 5. In this example, system 102 provides a “Best Matching Option 1 for Business Application Z” recommendation 704, a “Best Alternate Option 2 for Business Application Z” recommendation 706, and a “Close Matching, Satisfying All High Priorities for Business Application Z” recommendation 708. In an example, system 102 may send the recommendations 328 to the first computing device for display. In another example, recommendation engine 210 may send recommendation implementation data 330 to one or more of the cloud servers included within or otherwise associated with the “Best Matching Option 1” platform solution recommendation 702 to initiate deployment or execution of the Business Application Z application according to the “Best Matching Option 1 for Business Application Z” recommendation 704.

Moving to FIG. 7B, in an example the first computing device may provide a display 710, e.g., computing device 104 may provide a display via the display apparatus 120 (FIG. 1), to modify the requirements that were previously received by system 102. In an example, the modification may take place as a result of the recommendations 702 (FIG. 7A) having been provided to the first computing device for display to a user, and the user having determined that none of the recommendations 702 are acceptable and that the requirements 602 (FIG. 6A) should be modified. In an example, a user at the first computing device may be presented with a display 710 including an invitation 712 to modify a requirement (e.g., “Would you like to change any of your requirements?”), and a graphic user interface to enable the user to supply a change, update, or other modification 714 for one of the original requirements 602 (e.g., changing “total cost should not exceed $1000” to “total cost should not exceed $2000”). The first computing device may then in turn send, and system 102 may receive, the modification 714. Responsive to receipt of the modification 714, system 102 may determine a second or updated recommendation and send the send the second or updated recommendation to the first computing device for display. In another example, system 102 may send the second or updated recommendation to one or more of the cloud servers included within or otherwise associated with second recommendation, in order to initiate deployment or execution of the Business Application Z according to the second recommendation.

### Operation

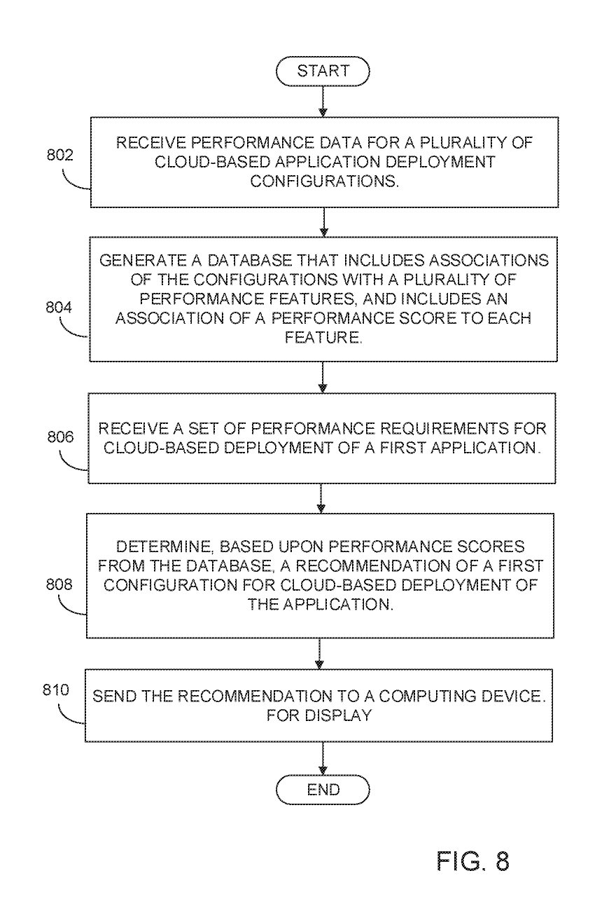

FIG. 8 is a flow diagram of steps taken to implement a method for providing media navigation recommendations. In discussing FIG. 8, reference may be made to the components depicted in FIGS. 2 and 4. Such reference is made to provide contextual examples and not to limit the manner in which the method depicted by FIG. 8 may be implemented. Performance data for a plurality of cloud-based application deployment configurations is received (block 802). Referring back to FIGS. 2 and 4, performance data engine 202 (FIG. 2) or performance data module 406 (FIG. 4), when executed by processing resource 404, may be responsible for implementing block 802.

A database is generated. The database includes associations of the configurations with a plurality of performance features, and includes an association of a performance score to each feature (block 804). Referring back to FIGS. 2 and 4, database engine 204 (FIG. 2) or database module 408 (FIG. 4), when executed by processing resource 404, may be responsible for implementing block 804.

A set of performance requirements for cloud-based deployment of a first application is received (block 806). Referring back to FIGS. 2 and 4, requirements engine 206 (FIG. 2) or requirements module 410 (FIG. 4), when executed by processing resource 404, may be responsible for implementing block 806.

A recommendation of a first configuration for cloud-based deployment of the first application is determined based upon performance scores from the database (block 808). Referring back to FIGS. 2 and 4, determination engine 208 (FIG. 2) or determination module 412 (FIG. 4), when executed by processing resource 404, may be responsible for implementing block 808.

The recommendation is sent to a computing device for display (block 810). Referring back to FIGS. 2 and 4, recommendation engine 210 (FIG. 2) or recommendation module 414 (FIG. 4), when executed by processing resource 404, may be responsible for implementing block 810.

### CONCLUSION

FIGS. 1-8 aid in depicting the architecture, functionality, and operation of various embodiments. In particular, FIGS. 1-4 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s). Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory” is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 8 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims. All of the features disclosed in this specification (including any accompanying claims, abstract and drawings), and/or all of the steps of any method or process so disclosed, may be combined in any combination, except combinations where at least some of such features and/or steps are mutually exclusive.

What is claimed is:

1. A system for determining cloud-based application deployment recommendations, comprising:
a performance data engine, to receive performance data for a plurality of cloud-based application deployment configurations;
a database engine to generate a database that includes associations of the configurations with a plurality of performance features, and includes an association of a performance score to each feature;
a requirements engine, to receive a set of performance requirements for cloud-based deployment of a first application;
a determination engine, to determine, based upon performance scores from the database, a recommendation of a first configuration for cloud-based deployment of the first application; and
a recommendation engine, to send the recommendation to a computing device.

2. The system of claim 1, wherein the set of performance requirements includes a requirement of at least one of cost, performance, quality of service, security, geographic location, reliability, application availability, and disaster recovery capability.

3. The system of claim 1, wherein the performance data engine is to generate the performance scores based upon performance data included within at least one of a product manual, support matrix, performance test report, product website, data sheet, and pricing guide.

4. The system of claim 1, wherein the performance data engine is to capture behavior data indicative of the first application in a plurality of cloud-based deployment configurations, and generate the performance scores based upon the behavior data.

5. The system of claim 1, wherein receiving performance data includes automatically receiving performance data elements over a time period.

6. The system of claim 1, wherein the set of performance requirements received includes semantic requirements, and wherein the requirements engine is to
access a repository that includes conversion data associating semantic performance values with numerical requirements, and
convert the semantic requirements to numerical requirements based upon the conversion data.

7. The system of claim 1, wherein the received requirements are requirements provided to a first computing device via a user interface at the first device, and wherein sending the recommendation to a computing device includes sending the recommendation to the first device for display.

8. The system of claim 7, wherein responsive to receipt of a modification to the requirements, the modification provided to the first computing device via the interface, the determination engine is to send a second recommendation to the first device for display.

9. The system of claim 1, wherein the recommendation engine is to send data to a cloud server to initiate deployment of the first application at the cloud server according to the recommendation.

10. The system of claim 1, wherein the each of the plurality of cloud-based application deployment configurations, when compared to another configuration within the plurality, includes a differentiating element.

11. A memory resource storing instructions that when executed cause a processing resource to implement a system to determine cloud-based application deployment recommendations, the instructions comprising:
a performance data module, to receive performance data for a plurality of cloud-based application deployment configurations;
a database module to generate a database that includes associations of the configurations with a plurality of performance features, and includes an association of a performance score to each feature;
a requirements module, to receive a set of performance requirements for cloud-based deployment of a first application, the requirements having been provided to a first computing device via a user interface at the first device;
a determination module, to determine, based upon performance scores from the database, a recommendation of a first configuration for cloud-based deployment of the application; and
a recommendation module, to send the recommendation to the first device for display.

12. The memory resource of claim 11, wherein the performance data module includes instructions to generate the performance scores based upon the performance data included within at least one of a product manual, support matrix, performance test report, product website, data sheet, and pricing guide.

13. The memory resource of claim 11, wherein the performance data includes behavior data indicative of the first application in a plurality of cloud-based deployment configurations, and wherein performance data module includes instructions to capture the behavior data and to generate the performance scores based upon the behavior data.

14. A method for determining cloud-based application deployment recommendations, comprising
receiving performance data for a plurality of cloud-based application deployment configurations;
generating a database that includes associations of the configurations with a plurality of performance features, and includes an association of a performance score to each feature;
receiving a set of performance requirements for cloud-based deployment of a first application;
accessing a repository that includes conversion data associating semantic performance values with numerical requirements, and
converting the semantic requirements to numerical requirements based upon the conversion data;
determining, based upon performance scores from the database, a recommendation of a first configuration for cloud-based deployment of the application; and
sending the recommendation to a computing device.

15. The method of claim 14, wherein receiving performance data includes automatically receiving performance data elements over a time period.
